(19) United States
(12) Patent Application Publication
(10) Pub. No.: US 2022/0148744 A1
(43) Pub. Date: May 12, 2022

(54) COMPACT NUCLEAR REACTOR SYSTEM

(71) Applicant: Radiant Industries, Incorporated, El Segundo, CA (US)

(72) Inventor: Doug Bernauer, El Segundo, CA (US)

(21) Appl. No.: 17/522,678

(22) Filed: Nov. 9, 2021

Related U.S. Application Data
(60) Provisional application No. 63/111,517, filed on Nov. 9, 2020.

(51) Int. Cl. G21C 7/12; G21C 5/14; G21C 5/12

(52) U.S. Cl. CPC G21C 7/12; G21C 5/12; G21C 5/14

(57) ABSTRACT

A compact nuclear reactor system can include a set of nuclear reactor each including: a moderating body; a heat pipe disposed within the moderating body and arranged substantially parallel to the longitudinal axis; nuclear fuel arranged within the moderating body and configured to heat a working fluid passable through the heat pipe; and a neutron moderator arranged within the moderating body and configured to slow a rate of fission within the moderating body. The compact nuclear reactor system can also include a control system including: a rotatable sleeve defining a first portion including a neutron poison material; and a second portion including a neutron transparent material. The compact nuclear reactor system can also include a drive system connected to the sleeve and configured to rotate the sleeve about the sleeve axis to control neutron flux between the set of nuclear reactor cores.

### CROSS-REFERENCE TO RELATED APPLICATIONS

This Application claims the benefit of U.S. Provisional Application No. 63/111,517 filed on 9 Nov. 2020, which is incorporated in its entirety by this reference.

### TECHNICAL FIELD

This invention relates generally to the field of nuclear power systems and more specifically to a new and useful compact nuclear reactor system in the field of nuclear power systems.

### BRIEF DESCRIPTION OF THE FIGURES

FIG. 1 is a schematic representation of an example implementation of a first system;

FIG. 2 is a schematic representation of a variation of the example implementation of the first system;

FIG. 3 is a schematic representation of another variation of the example implementation of the first system;

FIG. 4 is a schematic representation of another variation of the example implementation of the first system;

FIG. 5 is a schematic representation of a variation of the example implementation of the first system;

FIG. 6 is a schematic representation of a variation of the example implementation of the first system; and

FIG. 7 is a schematic representation of a variation of the example implementation of the first system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

1. System

As shown in the FIGURES, a compact nuclear reactor system 100 can include a set of nuclear reactor cores arranged around a longitudinal axis. As shown in the FIGURES, each of the set of nuclear reactor cores can further include: a moderating body; a heat pipe disposed within the moderating body and arranged substantially parallel to the longitudinal axis; nuclear fuel arranged within the moderating body and configured to heat a working fluid passable through the heat pipe; and a neutron moderator arranged within the moderating body and configured to slow a rate of fission within the moderating body. The compact nuclear reactor system 100 can also include a control system including: in a subset of the set of nuclear reactor cores, a sleeve defining a sleeve axis arranged about the moderating body such that the sleeve axis is substantially parallel to the longitudinal axis. As shown in the FIGURES, the sleeve can include: a first portion including a neutron poison material; and a second portion including a neutron transparent material. The compact nuclear reactor system 100 can also include a drive system connected to the sleeve and configured to rotate the sleeve about the sleeve axis to control neutron flux between the set of nuclear reactor cores.

In one variation of the example implementation, the system 100 can further include a heat exchange system in communication with the set of nuclear reactor cores and configured to operate in a first state within a first temperature range; and a heat exchange controller connected to the heat exchange system and configured to direct the control system to rotate the sleeve to adjust a neutron flux in response to the heat exchange system operating in a second state different from the first state.

In another variation of the example implementation, the system 100 can include a set of peripheral moderating bodies, each of the set of peripheral moderating bodies: defining a substantially elongated body along a peripheral moderator axis substantially parallel with the longitudinal axis; and arranged at a radial distance between the peripheral moderator axis and the longitudinal axis. Moreover, the system 100 can further include a central moderating body defining a substantially elongated body along a central moderator axis substantially coaxial with the longitudinal axis.

As shown in the FIGURES, in another variation of the example implementation, the system 100 can include a first nuclear reactor core arranged around a longitudinal axis and including: a first moderating body; a first heat pipe disposed within the first moderating body and arranged substantially parallel to the longitudinal axis; first nuclear fuel arranged within the first moderating body and configured to heat a working fluid passable through the first heat pipe; a first neutron moderator arranged within the first moderating body and configured to slow a rate of fission within the first moderating body. As shown in the FIGURES, the system 100 can also include a second nuclear reactor core arranged around a longitudinal axis and including: a second moderating body; a second heat pipe disposed within the second moderating body and arranged substantially parallel to the longitudinal axis; a second nuclear fuel arranged within the second moderating body and configured to heat a working fluid passable through the second heat pipe; and a second neutron moderator arranged within the second moderating body and configured to slow a rate of fission within the second moderating body.

As shown in the FIGURES, the system 100 can also include a control system including: a sleeve defining a sleeve axis arranged about the first moderating body such that the sleeve axis is substantially parallel to the longitudinal axis. The sleeve can include: a first portion including a neutron poison material; and a second portion including a neutron transparent material. As shown in the FIGURES, the system 100 can also include a drive system connected to the sleeve and configured to rotate the sleeve about the sleeve axis to adaptively and/or responsively control neutron flux between the first nuclear reactor core and the second nuclear reactor core.

2. Applications

Generally, the system 100 described herein is suitable for deployment and use in any application for which controlled nuclear power is either required or desired. More specifically, the system 100 can be deployed in terrestrial and space environments in which the space constraints, packaging constraints, weight constraints, or a combination thereof prohibit or otherwise limit the use of conventionally-designed compact nuclear reactor systems. For example, the system 100 can be deployed temporarily or semi-permanently at terrestrial sites including: austere environments such as military forward operating bases, remote mineral extraction sites, remote settlements, villages, or depots. Additionally, the system 100 can be deployed in urban environments to provide residential power and/or to supplement existing power infrastructure including renewable energy power production that may exhibit uneven or cyclical energy production (e.g., irregular solar radiation or wind speed). The system 100 can be implemented in a compact and portable configuration that permits easy integration into existing power infrastructure to provide reliable and controllable nuclear power on demand.

Moreover, as described in detail below, the system 100 controls neutron flux, fission reaction, and heat production through the use of self-contained, rotatable sleeves that selectively permit the passage of neutrons between sets of nuclear reactor cores. In doing so, the system 100 eliminates the need for cumbersome, costly, and space-consuming apparatuses such as control rods that must extend in and out of the nuclear reactor cores in order to control the production of heat and ensure that the system 100 remains stable. As a result, the system 100 can be deployed in a multitude of additional environments and/or applications for which nuclear power production is desirable but previously unattainable due to size, weight, and packaging constraints.

In one example implementation, the system 100 can be deployed for long-range space travel for manned or unmanned space vehicles and/or extraterrestrial settlements (e.g., lunar or Martian settlements). Because of the compact and lightweight configurations attainable by the system 100, spacecraft designers may have an increased range of options to design and build a coming generation of long-range and/or long-duration space vehicles that can provide consistent and reliable power throughout the duration of their journey. Moreover, because of the lightweight and compact design of the system 100, it can also be deployed on land-based vehicles (terrestrial, lunar, Martian) to provide consistent electrical and/or heat power and thereby enable movement about the surface.

In one variation of the system 100 described in detail below, the system 100 can include or be coupled with a Stirling engine that is configured to perform work in response to a temperature gradient between two components of the system 100. For example, the system 100 can include a Stirling engine that is: thermally coupled to the nuclear reactor cores via a set of heat pipes; and thermally coupled to a radiator configured and shaped to dissipate heat from the working fluid into the environment. In operation, the system 100 can implement controls described herein to achieve and/or maintain a temperature of the working fluid as it passes through the nuclear reactor cores by adjusting a fission rate within the nuclear reactor cores. As the system 100 is configured to continuously and responsively adjust its power production based upon neutron flux and/or temperature measurements, a Stirling engine included with or coupled to the system 100 can operate at a maximum efficiency for a long duration.

These and other features, applications, and advantages of the system 100 are described below in detail with reference to the FIGURES.

3. Nuclear Reactor Cores

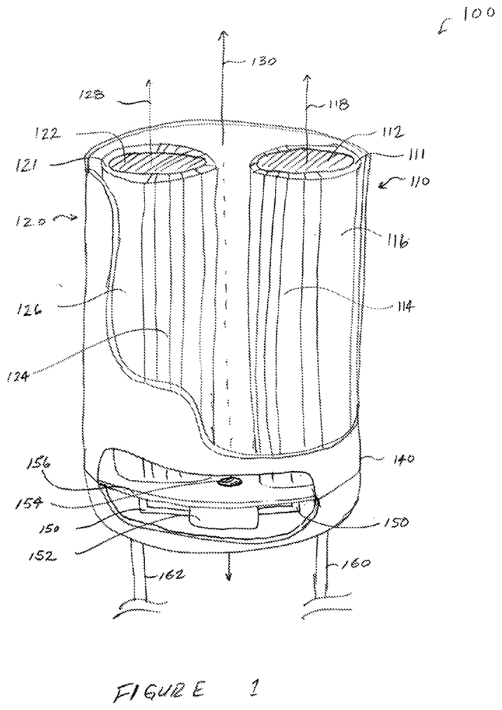

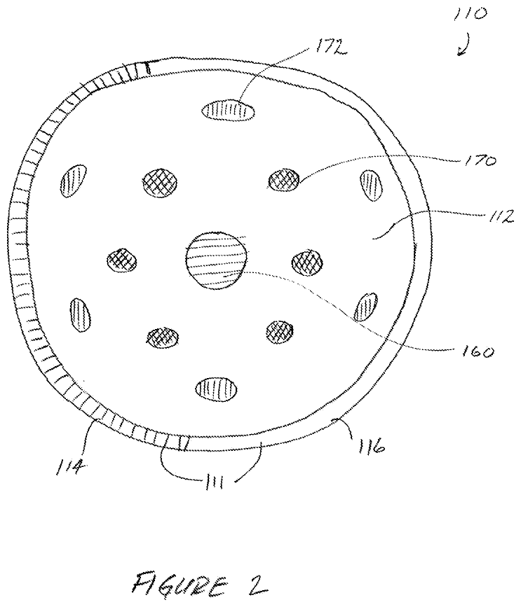

As shown in FIGS. 1 and 2, the system 100 can include a set of nuclear reactor cores 110, 120 arranged around a longitudinal axis 130. As noted above, the nuclear reactor cores 110, 120 can be arranged within a compact nuclear reactor system 100 designed or configured to provide heat and/or electrical power to a system load (e.g., a terrestrial load or a space vehicle) defining space-limiting packaging requirements. Accordingly, the system 100 can define a longitudinal axis 130 as a reference axis about and/or along which other elements of the system 100 are arranged. However the longitudinal axis may not be aligned along the longest/largest dimension of the system 100 depending upon individual packaging requirements.

As shown in FIGS. 1 and 2, each of the set of nuclear reactor cores 110, 120 can include a moderating body 112, 122 that is configured to provide structural definition and neutron moderation for nuclear fuel. Generally, the moderating body 112, 122 can include or define a rigid structure that defines sets of channels extending along its height, including: a first set of fuel channels within which nuclear fuel can be disposed, arranged, and/or flow; and a set of vertical flow channels or heat pipes 160, 162 through which an operating fluid (e.g., helium) passes and is heated by the nuclear fuel during operation of the system 100. For example, the set of heat pipes 160, 162 can be patterned across the moderating body 112, 122 and can extend fully through the moderating body 112, 122 substantially parallel to the longitudinal axis 130 of the system 100 such that heated working fluid flows through the set of heat pipes 160, 162 and to a heat exchange system (described below).

Generally, the moderating body 112, 122 can be composed of or manufactured in a material such as graphite that slows emitted neutrons and increases the probability that these emitted neutrons will be absorbed by adjacent nuclear fuel atoms, thereby maintaining the criticality of the nuclear fuel and the continuous production of heat through fission reactions. In one variation of the example implementation, the moderating body 112, 122 can include a monolithic graphite prismatic block including or defining a set of channels, pockets, holes, and/or passages machined or manufactured therein. Alternatively, the moderating body 112, 122 can include a set of graphite prismatic blocks, each including or defining a set of channels, pockets, holes, and/or passages machined or manufactured therein, arranged in a polylithic unitary structure.

As shown in FIG. 2, in one variation of the example implementation, the moderating body 112 can include or define a set of channels arranged substantially parallel to the longitudinal axis 130 within which nuclear fuel 170 can be arranged or disposed. In another variation of the example implementation, the nuclear fuel 170 can include a tristructural-isotropic uranium oxycarbide compact (TRISO) at an initial enrichment range between 15% and 20%, (e.g., approximately 19% initial enrichment). Each nuclear fuel compact 170 can define a structure ranging between one and six centimeters along a long axis and ranging between 0.5 and three centimeters along a short axis. The nuclear fuel compacts 170 can be arranged in the fuel channels in a random lattice within a graphite matrix. Alternatively, the nuclear fuel compacts 170 can be arranged in a graded or structured lattice within a graphite matrix. In another alternative, the matrix in which the nuclear fuel compacts 170 are arranged can include neutron moderator materials to moderate the emission and capture of neutrons. In other variations of the example implementation, the nuclear fuel 170 can include (additionally or alternatively): uranium oxide, uranium silicide, uranium carbide, uranium nitride, etcetera.

As shown in FIG. 2, in another variation of the example implementation, the moderating body 112 can include or define a second set of channels within which a neutron moderator 172 can be arranged or disposed. Example neutron moderator 172 materials can include Zirconium hydride, Yttrium hydride, Beryllium, or a combination or subcombination thereof.

As shown in FIG. 2, in one example implementation of the system 100, the nuclear fuel 170 and/or neutron moderator 172 can be arranged in a substantially symmetrical or uniform geometry about a central axis of the moderating body 112. For example, FIG. 2 illustrates an example geometry of the moderating body 112 in which a set of six channels containing nuclear fuel 170 and a set of six channels containing neutron moderator 172 are arranged symmetrically about the heat pipe 160. However, in other variations or alternative geometries of the system 100, the moderating body 112 can include any number of channels containing nuclear fuel 170 or nuclear poison 172 arranged in symmetrical or asymmetrical arrangements around a single heat pipe 160 or a set of heat pipes 160.

For example, the geometry of the channels containing nuclear fuel 170 and/or nuclear poison 172 may depend upon the geometry of the entire system 100, the number of nuclear reactor cores 110, 120 included in the system 100, and the geometric arrangement of the set of nuclear reactor cores 110, 120 within the system 100.

4. Control Systems

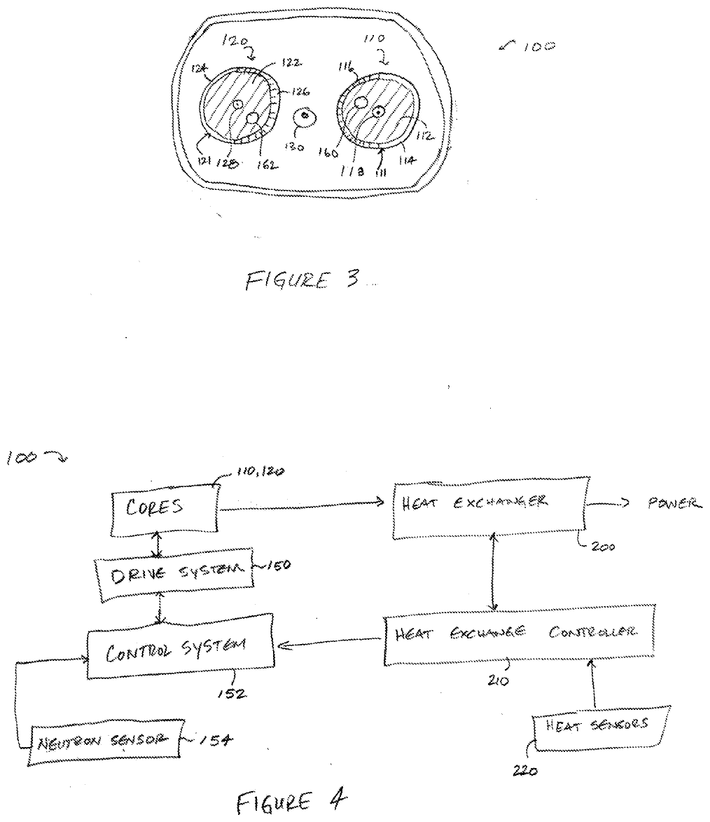

As shown in FIGS. 1, 2, 3, and 4, the system 100 can also include a control system configured to dynamically and/or responsively moderate neutron flux between two or more nuclear reactor cores 110, 120 in a set of nuclear reactor cores.

4.1 Nuclear Reactor Core Sleeves

In one variation of the example implementation, the system 100 can include: in a subset of the set of nuclear reactor cores 110, 120, a sleeve 111, 121 defining a sleeve axis 118, 128 arranged about the moderating body 112, 122 such that the sleeve axis 118, 128 is substantially parallel to the longitudinal axis 130. Generally, each sleeve 111, 121 can include a first portion 114, 124 including or manufactured from a neutron poison material; and a second portion 116, 126 including or manufactured from a neutron transparent material. As described in detail below, the sleeve 111, 121 is composed of or manufactured from distinct materials (e.g., first and second portions 114, 116, 124, 126) and configured to be rotatable about each respective moderating body 112, 122 such that a neutron flux between the set of nuclear reactor cores 110, 120 can be dynamically and/or responsively adjusted.

As shown in FIG. 2, each sleeve 111 can generally include a first portion 114 that is composed of or manufactured from a neutron absorbent or neutron poison material, such as boron carbide. The second portion 116 of the sleeve 111 can be any neutron transparent material, including for example moderating materials such as graphite or silicon carbide. In one variation of the example implementation, the sleeve 111 can be a unitary structure of neutron transparent material (e.g., a graphite or silicon carbide annulus) with a neutron poison material (e.g., boron carbide) disposed thereon over the first portion 114 via plating, painting, pasting, or otherwise affixing or adhering the neutron poison material to a first portion 114 of the surface of the sleeve 111. Alternatively, the sleeve 111 can be a non-unitary structure including separate portions (e.g., first and second portions 114, 116) that are transiently or permanently affixed to each other and cooperatively define a structure having distinct or variable neutron absorption and transmission properties.

In another variation of the example implementation shown in FIG. 2, the sleeve 111 defines a generally cylindrical or annular geometry surrounding the moderating body 112 of the nuclear reactor core 110. In such a configuration, the first portion 114 can include a neutron poison arranged, disposed, or located along a first range of radial angles relative to the sleeve axis 118. For example, in a system 100 including a set of two nuclear reactor cores, the first range of radial angles relative to the sleeve axis 118 can span approximately one hundred twenty degrees such that approximately one third of the sleeve surface includes or is composed of a neutron poison. In a system 100 including more than two nuclear reactor cores, the first range of radial angles relative to the sleeve axis can span a lesser or greater range of angles, depending upon the configuration of the nuclear reactor cores within the system 100.

As shown in FIG. 2, the sleeve 111 can further include a second portion 116 that is substantially transparent to neutrons (e.g., composed of one of silicon carbide or graphite) and arranged across a second range of radial angles relative to the sleeve axis 118. Generally, the angles covered by the second portion 116 and the first portion 114 will sum to three hundred sixty degrees in a symmetrical configuration such as a cylinder. Thus, if the first portion 114 of the sleeve 111 spans approximately one hundred twenty degrees about the sleeve axis 118, then the second portion 116 spans approximately two hundred forty degrees about the sleeve axis 118. As noted above, in alternate configurations the system 100 can include more than two nuclear reactor cores, in which case the relative angles of the first portion 114 and the second portion 116 can be modified to moderate and/or suppress neutron transmission between nuclear reactor cores during operation of the system 100.

In another variation of the example implementation of the system 100, the sleeve 111 can further define a third portion disposed adjacent to and/or within one or both of the first portion 114 or the second portion 116. For example, the third portion of the sleeve 111 can include or be composed of a different neutron poison material, a different neutron moderating material, or a composite, doped, or blended material that functions to transition between neutron absorption and neutron transparency. For example, the third portion of the sleeve 111 can be arranged at transition points between the first portion 114 and the second portion 116 such that the neutron flux emanating from the nuclear reactor core no is gradually increased along an angular transition from the first portion 114 to the second portion 116 and gradually decreased along an angular transition from the second portion 116 to the first portion 114.

In another variation of the example implementation, the first portion 114 can include or be composed of a layer of neutron poison material that is of substantially uniform thickness as measured along a radial line emanating orthogonal to the sleeve axis 118. For example, the first portion 114 can include a boron carbide plate, layer, or component that is of uniform thickness throughout its entire angular span.

Alternatively, the first portion 114 can include or be composed of a layer of neutron poison material that is of substantially non-uniform thickness as measured along a radial line emanating orthogonal to the sleeve axis 118. For example, the thickness of the first portion 114 can be graded across its angular span such that it is thicker along lines of greater potential neutron flux and thinner along lines of lesser potential neutron flux, as determined according to the number of nuclear reactor cores and their geometric arrangement within the system 100.

In other variations and alternative configurations of the example implementation, the sleeve 111, 121 can define other geometries or cross-sections. For example, in some alternative configurations, the sleeve 111, 121 can define a triangular cross-section and include one or more surfaces or sides including or defining materials with distinct neutron absorption properties. For example, in a triangular configuration, one side of the triangular sleeve 111, 121 can include or be composed of a neutron poison material and the other two sides of the triangular sleeve can include or be composed of a neutron transparent or moderating material. In this example alternative configuration, if the triangular cross-section is an equilateral triangle, then the first side of the triangle (e.g., a boron carbide surface) would absorb or substantially absorb neutrons spanning a one hundred twenty degree angle (measured in a plane normal to the sleeve axis 118) while the second and third sides of the triangle (e.g., graphite or silicon carbide) would moderate or transmit neutrons spanning a two hundred forty degree angle (measured in a plane normal to the sleeve axis).

In still other variations or alternative configurations of the example implementation, the sleeve 111, 121 can define any other polygonal cross-section (e.g., rectangular, square, rhomboid, pentagonal, hexagonal, etcetera) and include or define sides surfaces or sides including or defining materials with distinct neutron absorption properties. Alternatively, the sleeve 111, 121 can define a non-polygonal cross-section or an asymmetrical cross-section (e.g., tear-drop, oblong, elliptical, etcetera). Furthermore, the system 100 can include a set of nuclear reactor cores, some (or all) of which are enshrouded in sleeves 111, 121 having distinct cross-sections as described above depending upon the arrangement, geometry, and packaging of the system 100 and the nuclear reactor cores.

4.2. Drive System

As shown in FIGS. 1 and 4, the system 100 can further include a drive system 150 connected to the sleeve and configured to rotate the sleeve 111, 121 about the sleeve axis 118, 128 to control neutron flux between the set of nuclear reactor cores 110, 120. Generally, the drive system 100 can be arranged adjacent the sleeve(s) 111, 121 within the system 100 such that the drive system can engage, actuate, and rotate each sleeve 111, 121 about the sleeve axis 118, 128 to adjust a relative position of the first portion 114 and the second portion 116 of the sleeve 111, 121 relative to the other nuclear reactor cores and/or the longitudinal axis 130.

In one variation of the example implementation, the drive system 150 can include a mechanical or electro-mechanical rotor/stator pair, motor, gear-box, or any combination thereof that is mechanically and/or electrically coupled to the sleeve and rotate the sleeve 111, 121 about the sleeve axis 118 and thereby adjust the position of the first portion 114 of the sleeve relative to another (or a set of) nuclear reactor core 110, 120 in the system 100. Generally, the sleeve 111, 121 is rotatable about a static moderator block 112, 122 (within the frame of reference of the system 100). However, in alternative variations of the example implementation, the sleeve 111, 121 and the moderator block 112, 122 can rotate in unison as a singular rotatable nuclear reactor core 110, 120 within the system 100. In still other variations of the example implementation, a subset of sleeves 111, 121 and the moderator blocks 112, 122 can be configured as a unified and rotatable nuclear reactor core 110, 120 within the set of nuclear reactor cores within the system 100.

In one variation of the example implementation, the drive system 150 can be arranged within a singular pressure vessel containing the system 100. Alternatively, the drive system 150 can be arranged external to the pressure vessel containing the nuclear reactor cores 110, 120 and mated or coupled to the sleeves 111, 121 through a barrier, shield, or boundary separating the mechanism of the drive system 150 from the nuclear reactor cores 110, 120.

For example, as shown in FIG. 1, the drive system 150 can be arranged opposite a radiation shield 156 that shields the drive system 150 from incident radiation emitted by the nuclear reactor cores 110, 120 and permits the drive system 150 to be accessed, adjusted, and/or repaired while substantially protected from incident radiation. In one variation of the example implementation, the drive system 150 can be coupled to a sensor 154 in communication with the set of nuclear reactor cores 110, 120 and configured to generate a signal representative of a neutron flux parameter. For example, the sensor 154 can include a neutron sensor, a neutron/gamma sensor, a temperature sensor, a pressure sensor, or any combination thereof that is configured to receive and interpret incident radiation and/or energy and generate a signal indicative of a neutron flux within the system 100.

As shown in FIG. 1, the drive system 150 can also include and/or communicate with a controller 152 connected to the sensor 154 and configured to direct the drive system 150 to rotate the sleeve 111, 121 to moderate neutron flux in response to the signal. As noted above, in one variation of the example implementation, the sleeve 111, 121 rotates independently of the moderator block 112, 122 within the system 100 reference frame. In other alternative variations of the example implementation, the sleeve 111, 121 and the moderator block 112, 122 can be configured as a unitarily rotatable structure that the drive system 150 rotates in response to a neutron flux signal.

In operation, if the sensor 154 generates a signal indicating that the neutron flux within the system 100 is increasing (e.g., trending toward or above a threshold) indicative of excess fission within the nuclear reactor cores 110, 120, then the drive system 150 can rotate the sleeve 111 around the sleeve axis 118 such that the first portion 114 of the sleeve is proximate the longitudinal axis 130 and the second portion 116 of the sleeve is distal the longitudinal axis 130. As shown in the FIGURES, in configurations in which the nuclear reactor cores 110, 120 are arranged opposite the longitudinal axis 130, rotation of the sleeve 111 such that the first portion 114 is proximate the longitudinal axis 130 interposes the first portion 114 between the moderator blocks 112, 122 and thereby reduces neutron flux between the moderator blocks 112, 122.

In one variation of the example implementation, the drive system 150 can be configured to rotate a single sleeve 111 about a moderator block 112 such that the first portion 114 is proximate the longitudinal axis 130 and the second portion 116 is distal the longitudinal axis 130. In this variation of the example implementation, the drive system 150 can therefore slow, moderate, or impede neutron transmission between the moderator blocks 112, 122.

In another variation of the example implementation, the drive system 150 can be configured to rotate both sleeves 111, 121 about the moderator blocks 112, 122 such that the first portions 114, 124 are proximate the longitudinal axis 130 and the second portions 116, 126 are distal the longitudinal axis 130. In this variation of the example implementation, the drive system 150 can further slow, moderate, or impede neutron transmission between the moderator blocks 112, 122.

In another variation of the example implementation in which the system 100 includes more than two nuclear reactor cores 110, 120, the drive system 150 can be configured to rotate multiple (e.g., more than two) sleeves 111, 121 about the moderator blocks 112, 122 such that the first portions 114, 124 are proximate the longitudinal axis 130 and the second portions 116, 126 are distal the longitudinal axis 130. In this variation of the example implementation, the drive system 150 can further slow, moderate, or impede neutron transmission between the moderator blocks 112, 122.

In yet another variation of the example implementation, the drive system 150 can be configured to responsively and/or proportionally rotate the sleeve 111 at a proportional rate about a moderator block 112 such that the first portion 114 is proximate the longitudinal axis 130 and the second portion 116 is distal the longitudinal axis 130. If the controller 152 determines that a rate of increase in neutron flux is expected or anticipated to cause a neutron flux count to exceed a threshold, then the controller 152 can proportionally cause and/or direct the drive system 150 to rotate the sleeve 111 about the moderator block 112 as described above to slow, moderate, or impede neutron transmission between the moderator blocks 112, 122. For example, if the rate of increase in neutron flux is high (e.g., neutron flux is increasing rapidly), then the controller 152 can direct the drive system 150 to rapidly rotate the sleeve 111 about the moderator block 112 and rapidly counteract the increase in neutron flux. Conversely, if the rate of increase in neutron flux is low (e.g., neutron flux is increasing slowly), then the controller 152 can direct the drive system 150 to slowly rotate the sleeve 111 about the moderator block 112 to slowly moderate the increase in neutron flux.

In alternative variations of the example implementation, the drive system 150 can execute similar techniques and methods to counteract and/or moderate an increase in neutron flux in systems 100 having two or more sleeves 111, 121 rotatable about two or more nuclear reactor cores 110, 120.

In yet another variation of the example implementation, the drive system 150 can be configured to responsively and/or proportionally rotate the sleeve 111 at a proportional angular/impeding distance about a moderator block 112 such that the first portion 114 is proximate the longitudinal axis 130 and the second portion 116 is distal the longitudinal axis 130. If the controller 152 determines that a rate of increase in neutron flux is expected or anticipated to cause a neutron flux count to exceed a threshold, the controller 152 can proportionally cause and/or direct the drive system 150 to rotate the sleeve 111 about the moderator block 112 as described above to slow, moderate, or impede neutron transmission between the moderator blocks 112, 122. For example, if the rate of increase in neutron flux is high (e.g., neutron flux is increasing rapidly), then the controller 152 can direct the drive system 150 to fully rotate the sleeve 111 about the moderator block 112 such that the entirety of the first portion 114 is centered between the sleeve axis 118 and the longitudinal axis 130 in order to maximally counter the calculated increase in neutron flux. Conversely, if the rate of increase in neutron flux is low (e.g., neutron flux is increasing slowly), then the controller 152 can direct the drive system 150 to partially rotate the sleeve 111 about the moderator block 112 such that only an angular section of the first portion 114 is interposed between the sleeve axis 118 and the longitudinal axis 130 in order to slowly moderate the increase in neutron flux.

In alternative variations of the example implementation, the drive system 150 can execute similar techniques and methods to counteract and/or moderate an increase in neutron flux in systems 100 having two or more sleeves 111, 121 rotatable about two or more nuclear reactor cores 110, 120.

In operation, if the sensor 154 generates a signal indicating that the neutron flux within the system 100 is decreasing (e.g., trending toward or below a threshold) indicative of insufficient fission within the nuclear reactor cores 110, 120, then the drive system 150 can rotate the sleeve 111 around the sleeve axis 118 such that the first portion 114 of the sleeve 111 is distal the longitudinal axis 130 and the second portion 116 of the sleeve 111 is proximate the longitudinal axis 130. As shown in the FIGURES, in configurations in which the nuclear reactor cores 110, 120 are arranged opposite the longitudinal axis 130, rotation of the sleeve 111 such that the first portion 114 is distal the longitudinal axis 130 interposes the second portion 116 between the moderator blocks 112, 122 and thereby increases neutron flux between the moderator blocks 112, 122.

In one variation of the example implementation, the drive system 150 can be configured to rotate a single sleeve 111 about a moderator block 112 such that the second portion 116 is proximate the longitudinal axis 130 and the first portion 114 is distal the longitudinal axis 130. In this variation of the example implementation, the drive system 150 can therefore increase or sustain neutron transmission between the moderator blocks 112, 122.

In another variation of the example implementation, the drive system 150 can be configured to rotate both sleeves 111, 121 about the moderator blocks 112, 122 such that the second portions 116, 126 are proximate the longitudinal axis 130 and the first portions 114, 124 are distal the longitudinal axis 130. In this variation of the example implementation, the drive system 150 can further increase or sustain neutron transmission between the moderator blocks 112, 122.

In another variation of the example implementation in which the system includes more than two nuclear reactor cores 110, 120, the drive system 150 can be configured to rotate multiple (e.g., more than two) sleeves 111, 121 about the moderator blocks 112, 122 such that the second portions 116, 126 are proximate the longitudinal axis 130 and the first portions 114, 124 are distal the longitudinal axis 130. In this variation of the example implementation, the drive system 150 can further increase or sustain neutron transmission between the moderator blocks 112, 122.

In yet another variation of the example implementation, the drive system 150 can be configured to responsively and/or proportionally rotate the sleeve at a proportional rate about a moderator block 112 such that the second portion 116 is proximate the longitudinal axis 130 and the first portion 114 is distal the longitudinal axis 130. If the controller 152 determines that a rate of decrease in neutron flux is expected or anticipated to cause a neutron flux count to fall below a threshold, the controller 152 can proportionally cause and/or direct the drive system 150 to rotate the sleeve 111 about the moderator block 112, as described above, to increase or sustain neutron transmission between the moderator blocks 112, 122. For example, if the rate of decrease in neutron flux is high (e.g., neutron flux is decreasing rapidly), then the controller 152 can direct the drive system 150 to rapidly rotate the sleeve 111 about the moderator block 112 and rapidly counteract the decrease in neutron flux. Conversely, if the rate of decrease in neutron flux is low (e.g., neutron flux is decreasing slowly), then the controller 152 can direct the drive system 150 to slowly rotate the sleeve 111 about the moderator block 112 to slowly counteract the decrease in neutron flux.

In alternative variations of the example implementation, the drive system 150 can execute similar techniques and methods to counteract and/or moderate a decrease in neutron flux in systems 100 having two or more sleeves 111, 121 rotatable about two or more nuclear reactor cores 110, 120.

In yet another variation of the example implementation, the drive system 150 can be configured to responsively and/or proportionally rotate the sleeve 111 at a proportional angular/opening distance about a moderator block 112 such that the second portion 116 is proximate the longitudinal axis 130 and the first portion 114 is distal the longitudinal axis 130. If the controller 152 determines that a rate of decrease in neutron flux is expected or anticipated to cause a neutron flux count to fall below a threshold, the controller 152 can proportionally cause and/or direct the drive system 150 to rotate the sleeve 111 about the moderator block 112 as described above to increase or sustain neutron transmission between the moderator blocks 112, 122. For example, if the rate of decrease in neutron flux is high (e.g., neutron flux is decreasing rapidly), then the controller 152 can direct the drive system 150 to fully rotate the sleeve 111 about the moderator block 112 such that the entirety of the second portion 116 is centered between the sleeve axis 118 and the longitudinal axis 130 in order to maximally increase the potential neutron flux. Conversely, if the rate of decrease in neutron flux is low (e.g., neutron flux is decreasing slowly), then the controller 152 can direct the drive system 150 to partially rotate the sleeve 111 about the moderator block 112 such that only an angular section of the second portion 116 is interposed between the sleeve axis 118 and the longitudinal axis 130 in order to slowly moderate or counteract the decrease in neutron flux.

In alternative variations of the example implementation, the drive system 150 can execute similar techniques and methods to counteract and/or moderate a decrease in neutron flux in systems 100 having two or more sleeves 111, 121 rotatable about two or more nuclear reactor cores 110, 120.

In operation, the controller 152 and sensor 154 can cooperatively update and manage neutron flux within the system 100 by continuously and adaptively adjusting a position of the first and second portions 114, 116 of the sleeve 111 about the sleeve axis 118.

4.3 Heat Exchange System

As shown in FIG. 4, the system 100 can further include a heat exchange system 200 in communication with the set of nuclear reactor cores 110, 120 and configured to operate in a first state (high efficiency) at a first temperature range and a second state (low efficiency) within a second temperature range. The system 100 can also include a heat exchange controller 210 that is connected to the heat exchange system 200 and that is configured to direct the control system 152 to rotate the sleeve 111 to increase a neutron flux in response to the heat exchange system operating in the second state, (e.g. to increase the temperature of the working fluid and thereby increase the efficiency of the system 100).

In one variation of the example implementation, the heat exchange system 200 can include a heat engine that is coupled to the nuclear reactor cores 110, 120 through the heat pipes 160, 162. For example, the heat exchange system 200 can derive power (thermal or electrical) from a temperature difference in a working fluid, such as a fluid passable through the heat pipes 160, 162. In one alternative variation of the example implementation, the heat exchange system 200 can include a Stirling engine that receives and recycles a working fluid through the nuclear reactor cores 110, 120 and a radiator or heat sink. In operation, the system 100 can heat a working fluid at the nuclear reactor cores 110, 120 and cool the same working fluid at a heat sink, thereby cycling the working fluid through variations in temperature to drive the Stirling engine.

As shown in FIG. 4, the system 100 can also include a heat exchange controller 210 and a heat sensor 220. The heat exchange controller 210 can be configured to receive a heat sensor signal from the heat sensor 220, which can include: a temperature measurement at a component or position within the heat exchange system 200; a temperature range between a high temperature at or near the nuclear reactor cores 110, 120 and the heat sink; and/or a change or rate of change in either absolute temperature measurements or temperature range measurements.

For example, a Stirling engine efficiency can depend, in part, upon the breadth of the temperature range between its high and low temperature points or components. Accordingly, the heat sensor 220 can measure a temperature range as well as a rate of change in the temperature range and direct these signals to the heat exchange controller 210. In response to the temperature range and rate of change in temperature range signals, the heat exchange controller 210 can: determine an increase, decrease, or stability in efficiency of the system 100; generate a signal indicative of the increase, decrease, or stability in efficiency of the system 100; and transmit the signal indicative of the increase, decrease, or stability in efficiency of the system 100 to the control system 152.

In another variation of the example implementation, the control system 152 can receive the signal indicative of the increase, decrease, or stability in efficiency of the system 100 and incorporate the same into the neutron flux controls described in detail above. For example, if the control system 152 receives a signal indicative of a decrease in efficiency of the system 100, the control system 152 can direct the drive system 150 to incrementally increase the neutron flux (and therefore fission reactions) at the nuclear reactor cores 110, 120 to increase the temperature of the working fluid, increase the temperature range of the system 100, and increase the efficiency of the heat exchange system 200.

5. Example Geometries

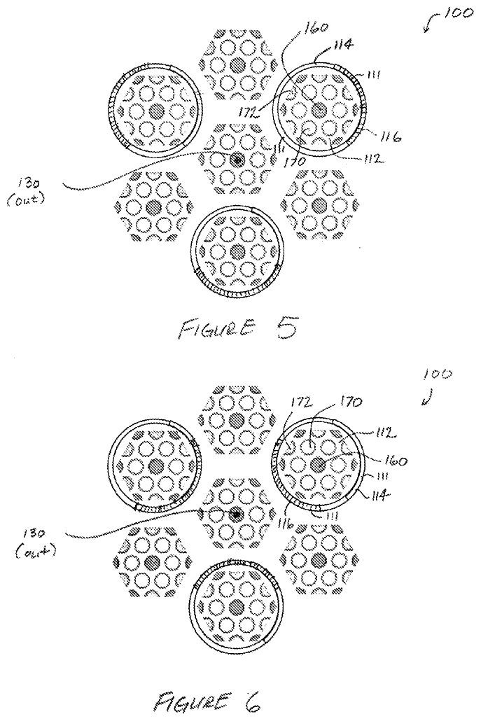

Generally, the system 100 can be configured in variations and alternative variations to those described herein. As noted above, in one configuration, the system 100 can include a pair of nuclear reactor cores 110, 120, each surrounded by a sleeve 111, 121 as shown in FIGS. 1, 2, and 3. In other configurations, the system 100 can include a set (e.g., more than two) of nuclear reactor cores, some or all of which are surrounded by a sleeve 111 as shown in FIGS. 5, 6, and 7.

In one example configuration shown in FIG. 5, the system 100 can include a central nuclear reactor core arranged along the longitudinal axis 130 and a set of six peripheral nuclear reactor cores arranged about a periphery of the central nuclear reactor core. In one variation of the example configuration, a subset of the nuclear reactor cores can be surrounded by a sleeve 111 including a first portion 114 and a second portion 116. As shown in FIG. 5, the system 100 can be arranged and/or operated in a relatively high neutron flux state in which each of the first portions 114 of the sleeves is arranged distal the central nuclear reactor core (e.g., distal the longitudinal axis 130) and therefore neutron flux between the set of seven nuclear reactor cores is unimpeded by the sleeves.

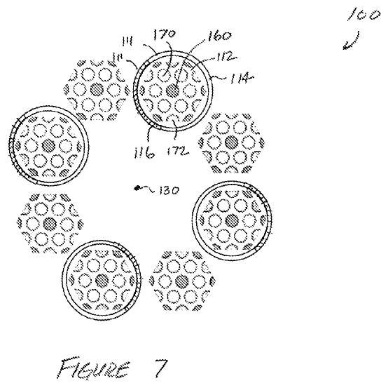

Conversely, as shown in FIG. 6, the system 100 can be arranged and/or operated in a relatively low neutron flux state in which each of the first portions 114 of the sleeve 111 is arranged proximate the central nuclear reactor core (e.g., proximate the longitudinal axis 130) and therefore neutron flux between the set of seven nuclear reactor cores is moderated or impeded by the sleeves 111.

As shown in FIGS. 5 and 6, a subset of three of the six peripheral nuclear reactor cores is contained within rotatable sleeves 111. However, in other variations of the system 100, a greater or lesser number of nuclear reactor cores can be contained within rotatable sleeves 111, not including the central nuclear reactor core. In other example configurations of the system geometry shown in FIGS. 5 and 6, all of the peripheral nuclear reactor cores can be contained within a rotatable sleeve 111. In other example configurations, the system 100 can include a central nuclear reactor core and a set of three (or four, or five, etcetera) peripheral nuclear reactor cores, each of which is contained within a rotatable sleeve 111.

In another example configuration of the system 100 shown in FIG. 7, the system 100 can include a set of eight nuclear reactor cores arranged about the longitudinal axis 130 and not including a central nuclear reactor core as shown in FIGS. 5 and 6. As shown in FIG. 7, a subset of four of the peripheral nuclear reactor cores can be contained within rotatable sleeves 111. In one example configuration, the subset of enshrouded peripheral nuclear reactor cores is arranged symmetrically and/or alternately with the unshrouded peripheral nuclear reactor cores. However, in other example geometries, the subset of enshrouded peripheral nuclear reactor cores can be arranged asymmetrically and/or in a non-alternating pattern with the unshrouded peripheral nuclear reactor cores. In other variations of the system geometry shown in FIG. 7, each of the peripheral nuclear reactor cores can be contained within rotatable sleeves 111.

In still other variations of the system geometry shown in FIGS. 5, 6, and 7, the subset of nuclear reactor cores arranged within the sleeves 111 can range from one nuclear reactor core to the entire set of nuclear reactor cores in the system 100. Generally, in geometries including a central nuclear reactor core, the central nuclear reactor core will not be contained within a sleeve 111. However, in some variations of the example implementation, a central nuclear reactor core can include a sleeve 111 having a set of first portions 114 and second portions 116 that are selectively alignable with peripheral nuclear reactor cores. For example, a central nuclear reactor core can include a sleeve 111 having first portions 114 at approximately 12, 3, 6, and 9 o'clock positions and second portions 116 interspersed between the 12, 3, 6, and 9 o'clock positions. Accordingly, the sleeve 111 about the central nuclear reactor core can be rotated by the drive system 150 to selectively align first portions 114 or second portions 116 with selected peripheral nuclear reactor cores, some or all of which can also include sleeves 111 as described herein.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A compact nuclear reactor system comprising:
a set of nuclear reactor cores arranged around a longitudinal axis, each of the set of nuclear reactor cores comprising:
a moderating body;
a heat pipe disposed within the moderating body and arranged substantially parallel to the longitudinal axis;
nuclear fuel arranged within the moderating body and configured to heat a working fluid passable through the heat pipe; and
a neutron moderator arranged within the moderating body and configured to slow a rate of fission within the moderating body; and
a control system comprising:
in a subset of the set of nuclear reactor cores, a sleeve defining a sleeve axis arranged about the moderating body such that the sleeve axis is substantially parallel to the longitudinal axis, the sleeve comprising:
a first portion comprising a neutron poison material; and
a second portion comprising a neutron transparent material; and
a drive system connected to the sleeve and configured to rotate the sleeve about the sleeve axis to control neutron flux between the set of nuclear reactor cores.

2. The system of claim 1, further comprising:
a sensor in communication with the set of nuclear reactor cores and configured to generate a signal representative of a neutron flux parameter; and
a controller connected to the sensor and configured to direct the drive system to rotate the sleeve to increase/reduce neutron flux in response to the signal.

3. The system of claim 1, further comprising:
a heat exchange system in communication with the set of nuclear reactor cores and configured to operate in a first state within a first temperature range; and
a heat exchange controller connected to the heat exchange system and configured to direct the control system to rotate the sleeve to adjust a neutron flux in response to the heat exchange system operating second state different than the first state.

4. The system of claim 1, wherein the subset of nuclear reactor cores comprises the set of nuclear reactor cores.

5. The system of claim 1, wherein the moderating body comprises a graphite block defining a substantially elongated body along a moderator axis substantially parallel to the longitudinal axis.

6. The system of claim 1, wherein the set of nuclear reactor cores comprises a set of peripheral moderating bodies, each of the set of peripheral moderating bodies:
defining a substantially elongated body along a peripheral moderator axis substantially parallel with the longitudinal axis; and
arranged at a radial distance between the peripheral moderator axis and the longitudinal axis.

7. The system of claim 6, further comprising a central moderating body defining a substantially elongated body along a central moderator axis substantially coaxial with the longitudinal axis.

8. The system of claim 7, wherein the subset of moderating bodies comprises at least one half of the set of peripheral moderating bodies excluding the central moderating body.

9. The system of claim 6, wherein the control system is configured to, in response to an increase in neutron flux, actuate the drive system to rotate the sleeve around the sleeve axis such that the first portion of the sleeve is proximate the longitudinal axis and the second portion of the sleeve is distal the longitudinal axis.

10. The system of claim 9, wherein the control system is configured to, in response to a decrease in neutron flux, actuate the drive system to rotate the sleeve around the sleeve axis such that the first portion of the sleeve is distal the longitudinal axis and the second portion of the sleeve is proximal the longitudinal axis.

11. system of claim 1, wherein each of the set of nuclear reactor cores comprises:
a moderating body comprising a graphite block;
nuclear fuel comprising TRISO fuel arranged within the moderating body and configured to heat a working fluid passable through the heat pipe; and
a neutron moderator comprising Yttrium-Hydride arranged within the moderating body and configured to slow a rate of fission within the moderating body.

13. The system of claim 11, wherein the sleeve comprises:
a first portion comprising boron carbide arranged across a first range of radial angles relative to the sleeve axis; and
a second portion comprising one of silicon carbide or graphite and arranged across a second range of radial angles relative to the sleeve axis.

14. The system of claim 13, wherein the first range of radial angles and the second range of radial angles sum to 360 degrees.

15. The system of claim 13, wherein the first portion comprising boron carbide comprises a layer of boron carbide of substantially uniform thickness as measured along a radial line emanating orthogonal to the sleeve axis.

16. The system of claim 13, wherein the first portion comprising boron carbide comprises a layer of boron carbide of graded thickness as measured along a radial line emanating orthogonal to the sleeve axis.

17. A compact nuclear reactor system comprising:
a first nuclear reactor core arranged substantially parallel to a longitudinal axis and comprising:
a first moderating body;
a first heat pipe disposed within the first moderating body and arranged substantially parallel to the longitudinal axis;
first nuclear fuel arranged within the first moderating body and configured to heat a working fluid passable through the first heat pipe; and
a first neutron moderator arranged within the first moderating body and configured to slow a rate of fission within the first moderating body;
a second nuclear reactor core arranged substantially parallel to the longitudinal axis and comprising:
a second moderating body;
a second heat pipe disposed within the second moderating body and arranged substantially parallel to the longitudinal axis;
second nuclear fuel arranged within the second moderating body and configured to heat a working fluid passable through the second heat pipe; and
a second neutron moderator arranged within the second moderating body and configured to slow a rate of fission within the second moderating body; and
a control system comprising:
a sleeve defining a sleeve axis arranged about the first moderating body such that the sleeve axis is substantially parallel to the longitudinal axis, the sleeve comprising:
a first portion comprising a neutron poison material; and
a second portion comprising a neutron transparent material; and
a drive system connected to the sleeve and configured to rotate the sleeve about the sleeve axis to control neutron flux between the first nuclear reactor core and the second nuclear reactor core.

18. The system of claim 17, wherein the control system further comprises:
a second sleeve defining a second sleeve axis arranged about the second moderating body such that the second sleeve axis is substantially parallel to the longitudinal axis, the second sleeve comprising:
a first portion comprising a neutron poison material; and
a second portion comprising a neutron transparent material; and
a drive system connected to the second sleeve and configured to rotate the second sleeve about the second sleeve axis to control neutron flux between the second nuclear reactor core and the first nuclear reactor core.

19. The system of claim 17, wherein the sleeve comprises:
a first portion comprising boron carbide arranged across a first range of radial angles relative to the sleeve axis; and
a second portion comprising one of silicon carbide or graphite and arranged across a second range of radial angles relative to the sleeve axis.

20. The system of claim 19, wherein the first range of radial angles and the second range of radial angles sum to 360 degrees.
